(19) United States
(12) Patent Application Publication
(10) Pub. No.: US 2024/0022908 A1
(43) Pub. Date: Jan. 18, 2024

(54) AUTHENTICATION USING A DIGITAL IDENTIFIER FOR UE ACCESS

(71) Applicant: Lenovo (Singapore) Pte. Ltd., New Tech Park (SG)

(72) Inventors: Sheeba Backia Mary Baskaran, Friedrichsdorf (DE); Apostolis Salkintzis, Athens (GR); Andreas Kunz, Ladenburg (DE)

(21) Appl. No.: 18/252,178

(22) PCT Filed: Nov. 6, 2020
(86) PCT No.: PCT/EP2020/081366

§ 371 Date: May 8, 2023

(51) Int. Cl. H04W 12/069; H04W 12/72; H04W 12/71; H04W 12/0431

(52) U.S. Cl. CPC H04W 12/069; H04W 12/72; H04W 12/71; H04W 12/0431

(57) ABSTRACT

Apparatuses, methods, and systems are disclosed for Digital Identifier-based authentication for network access. One apparatus includes a memory coupled to a processor, the memory storing instructions executable by the processor to control the apparatus to receive a first authentication request message containing UE identifier that is based on a Digital Identifier (“DIG-ID”) comprising a verifiably secure identity. The instructions are executable by the processor to control the apparatus to receive subscription information from a service provider identified using the DIG-ID, and to store the subscription information and UE security context containing at least one security key derived using the DIG-ID. The instructions are executable by the processor to control the apparatus to transmit the at least one security key.

### FIELD

The subject matter disclosed herein relates generally to wireless communications and more particularly relates to supporting Digital ID based user authentication to enable network access for a UE.

### BACKGROUND

The following abbreviations are herewith defined, at least some of which are referred to within the following description: Third Generation Partnership Project (“3GPP”), Fifth Generation Access Network (“5G-AN”), Fifth Generation Core Network (“5GC”), Fifth Generation System (“5GS”), Authentication, Authorization and Accounting (“AAA”), AAA Proxy (“AAA-P”), AAA Server (“AAA-S”), Positive-Acknowledgment (“ACK”), Authentication and Key Agreement (“AKA”), Access and Mobility Management Function (“AMF”), Application Programming Interface (“API”), Authentication Credential Repository and Processing Function (“ARPF”), Access Stratum (“AS”), Application Server (“AS”), Authentication Server Function (“AUSF”), Authentication Token (“AUTN”), Authentication Vector (“AV”), Base Station (“BS”), Blockchain Service Enabler Function (“BSEF”), Bandwidth Part (“BWP”), Clear Channel Assessment (“CCA”), Code Division Multiple Access (“CDMA”), Control Element (“CE”), Cyclic Prefix (“CP”), Channel State Information (“CSI”), Configured Grant (“CG”), Core Network (“CN”), Control Plane (“CP”), Decentralikzed Identifier (“DID”), Digital Identifier (“DIG-ID”), Digital Signature (“DS”), Distributed Ledger Technology (“DLT”), Digital Identification, Authentication and Trust Services Enabler Function (“D-IDASEF”), Digital ID-based Subscription Permanent Identifier (“D-SUPI”), Downlink Control Information (“DCI”), Downlink (“DL”), Discontinuous Transmission (“DTX”), Enhanced Clear Channel Assessment (“eCCA”), Electronic Identification, Authentication and Trust Services (“eIDAS”), Enhanced Mobile Broadband (“eMBB”), Evolved Node-B (“eNB”), Evolved Packet Core (“EPC”), Evolved Packet System (“EPS”), Evolved UMTS Terrestrial Radio Access (“E-UTRA”), Evolved UMTS Terrestrial Radio Access Network (“E-UTRAN”), European Telecommunications Standards Institute (“ETSI”), General Packet Radio Service (“GPRS”), Global System for Mobile Communications (“GSM”), Hybrid Automatic Repeat Request (“HARQ”), Home Subscriber Server (“HSS”), Home Public Land Mobile Network (“HPLMN”), Identity (“ID”, also an acronym for related concepts ‘Identifier’ or ‘Identification’), Identity Provider (“IDP”), Identity Service Provider (“IDSP”), Identity Framework (“IDF”), Information Element (“IE”), Internet-of-Things (“IoT”), Listen-Before-Talk (“LBT”), Long Term Evolution (“LTE”), Multiple Access (“MA”), Mobility Management (“MM”), Mobility Management Entity (“MME”), Mobile Network Operator (“MNO”), Master Session Key (“MSK”), Narrowband (“NB”), Negative-Acknowledgment (“NACK”) or (“NAK”), New Generation (5G) Node-B (“gNB”), New Generation Radio Access Network (“NG-RAN”, a RAN used for 5GS networks), New Radio (“NR”, a 5G radio access technology; also referred to as “5G NR”), NR using unlicensed spectrum (“NR-U”), Non-Access Stratum (“NAS”), Network Exposure Function (“NEF”), Number Used Once (“Nonce”), Network Slice Selection Assistance Information (“NSSAI”), Onboarding Assistance Information (“OAI”), Permissioned Distributed Ledger (“PDL”), Packet Data Unit (“PDU”, used in connection with ‘PDU Session’), Packet Switched (“PS”, e.g., Packet Switched domain or Packet Switched service), Primary Cell (“PCell”), Physical Downlink Control Channel (“PDCCH”), Packet Data Network (“PDN”), Physical Downlink Shared Channel (“PDSCH”), PDN Gateway (“P-GW”), Physical Hybrid Automatic Repeat Request Indicator Channel (“PHICH”), Physical Random-access Channel (“PRACH”), Physical Resource Block (“PRB”), Physical Uplink Control Channel (“PUCCH”), Physical Uplink Shared Channel (“PUSCH”), Public Land Mobile Network (“PLMN”), Quality of Service (“QoS”), Radio Access Network (“RAN”), Radio Resource Control (“RRC”), Random-Access Channel (“RACH”), Random-access Response (“RAR”), Reference Signal (“RS”), Registration Area (“RA”, similar to tacking area list used in LTE/EPC), Receive (“RX”), Radio Link Control (“RLC”), Single Carrier Secondary Cell (“SCell”), Shared Channel (“SCH”), Serving Gateway Security Anchor Function (“SEAF”), Subscription Identifier De-concealing Function (“SIDF”), (“S-GW”), Session Management (“SM”), Security Mode Command (“SMC”), Session Management Function (“SMF”), Serving Network Identifier (“SN Id”), Service Provider (“SP”), Single Network Slice Selection Assistance Information (“S-NSSAI”), Sounding Reference Signal (“SRS”), Self-Sovereign Identifier (“SSI”), Subscription Concealed Identifier (“SUCI”), Subscription Permanent Identifier (“SUPI), Timing Alignment Timer (“TAT”), Tracking Area (“TA”), Transport Block (“TB”), Transport Block Size (“TBS”), Timestamp (“TS”), Trust Service Provider (“TSP”), Transmission Time Interval (“TTI”), Transmit (“TX”), Unified Data Management (“UDM”), User Data Repository (“UDR”), Uplink Control Information (“UCI”), User Entity/Equipment (Mobile Terminal) (“UE”), Uplink (“UL”), User Plane (“UP”), Universal Mobile Telecommunications System (“UMTS”), UMTS Terrestrial Radio Access (“UTRA”), UMTS Terrestrial Radio Access Network (“UTRAN”), World Wide Web Consortium (“W3C”), and Worldwide Interoperability for Microwave Access (“WiMAX”). As used herein, “HARQ-ACK” may represent collectively the Positive Acknowledge (“ACK”) and the Negative Acknowledge (“NACK”) and Discontinuous Transmission (“DTX”). ACK means that a TB is correctly received while NACK (or NAK) means a TB is erroneously received. DTX means that no TB was detected.

The current 3GPP network restricts the user subscription identification related to the long-term MNO subscription provisioned in the UICC/USIM. In a scenario where a user can tend to use different 3rd party services via a different MNO network with which the user has no subscription, the user may need to buy a temporary subscription to use the 3rd party service via a different MNO.

### BRIEF SUMMARY

Disclosed are procedures for Digital ID-based authentication for network access. Said procedures may be implemented by apparatus, systems, methods, and/or computer program products.

One method of a UE includes acquiring a digital identifier (“DIG-ID”), said digital identifier comprising a verifiably secure identity, and generating a UE permanent identifier using the DIG-ID. Here, the UE permanent identifier indicates a service provider holding subscription information of the UE and a trust service provider that enabled the DIG-ID generation at the UE. The method includes sending a Registration request message to a mobile communication network and performing authentication using the DIG-ID. Here, the UE accesses a service provided by the service provider via the mobile communication network in response to successful authentication.

One method of a network function includes receiving a first authentication request message, the message containing a UE identifier that is based on a DIG-ID, said DIG-ID comprising a verifiably secure identity. The method includes receiving subscription information from a service provider, said service provider identified using the DIG-ID. The method includes storing the subscription information and UE security context in response to successful authentication of the UE using the DIG-ID. Here, the UE security context contains at least one security key derived using the DIG-ID. The method includes transmitting the at least one security key to a network function in the mobile communication network. Here, the at least one security key is used to protect traffic of the UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for Digital ID-based authentication for network access;

FIG. 2 is a diagram illustrating one embodiment of a procedure for primary authentication using Decentralized ID/Self Sovereign ID based SUPI for Network Access and MNO service;

FIG. 3A is a diagram illustrating one embodiment of a procedure for primary authentication using Decentralized ID/Self Sovereign ID based SUPI for Network Access;

FIG. 3B is a continuation of the procedure in FIG. 3A;

FIG. 3C is a continuation of the procedure in FIG. 3B;

FIG. 4A is a diagram illustrating one embodiment of a subscription permanent identifier that is based on a Digital ID;

FIG. 4B is a diagram illustrating one embodiment of a subscription concealed identifier that is based on a Digital ID;

FIG. 5 is a diagram illustrating one embodiment of a user equipment apparatus that may be used for Digital ID-based authentication for network access;

FIG. 6 is a diagram illustrating one embodiment of a network equipment apparatus that may be used for Digital ID-based authentication for network access;

FIG. 7 is a flowchart diagram illustrating one embodiment of a method for Digital ID-based authentication for network access; and

FIG. 8 is a flowchart diagram illustrating another embodiment of a method for Digital ID-based authentication for network access.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for Digital ID-based authentication for network access. Described herein is digital user/network subscription identifier-based subscriber/user authentication to enable on-demand network access and services for the UE. Also described is digital identifier-based subscription handling to mitigate Identity fraud and risks. The disclosure addresses the following problem related to the mobile networks.

The vertical service provider market is evolving with the digital transformation, whereas the current 3GPP mobile network does not support on-demand User ID and subscription management to enable User on-demand services from different service providers in the digital market. The current 3GPP network restricts the user subscription identification related to the long-term Mobile Network Operator (“MNO”) subscription provisioned in the UICC/USIM. In a scenario where a user can tend to use different 3rd party services via a different MNO network with which the user has no subscription, the user may need to buy a temporary subscription to use the 3rd party service via a different MNO.

Few use cases that require digital subscriber/customer identification and temporary subscription handling includes Pay per Use model (i.e., where the users buy and use services on-the-go without buying a dedicated SIM card), Temporary Service subscription (i.e., In Network as a service model, where in some locations, a 5G network can be available/deployed for ad hoc and/or temporary events, to provide 5G coverage and connectivity to local users or devices, e.g., Sport venues/stadiums, etc., The 5G network operator may allow users/devices to access specific on demand services, which could also be offered by other mobile operator(s) or 3rd party content provider(s), as additional revenue opportunities. Users/devices may (or not) be subscribers of the Network and/or service provider, but based on the need the users can do online sign-up (without going through the legacy KYC, identity and subscription handling process) and enjoy the services).

The Mobile Network Operators (“MNOs”) as part of Know-Your-Customer (“KYC”) requirements are subject to mandatory SIM registration obligations which require customers to present Government recognized identity credentials before a SIM card and related subscription can be activated. In most cases, these KYC regulations only allow customers to present identity documents that have been issued by government authorities, such as national identity cards, passports, or drivers' licenses.

However, KYC processes can be expensive, time-consuming, and potentially troublesome for service providers, particularly when MNOs are obligated to validate customers' ID credentials against a government database and are charged a fee for each validation query they make. In addition to the operating costs associated with customer enrollment, data protection and document management, cases of identity fraud can lead to heavy fines and damage a company's brand reputation.

As IoT devices explode in number, the embedded SIM technology is evolving and replacing the physical SIM cards. In general, the USIM/UICC stores the subscription information along with the IMSI (International mobile subscription Identifier) and they are responsible for authenticating subscribers on a mobile network, to access the network and to avail the subscription related services. The eSIM and iSIM largely dependent on Remote SIM Provisioning (“RSP”) solutions. Identity Fraud and complexity involved in KYC process related to SIM activation for network access becomes a huge threat to the mobile operators and subscribers.

With the increasing number of IoT devices, there is a higher chance that the devices without USIMs will also play a significant role in the IoT and vertical service ecosystem. Currently the mobile operators and 3GPP network supports only traditional KYC, i.e. the subscriber can obtain the SIM card and activate subscription only after a legacy identity check, e.g. passport, in the shop, afterwards SIM based subscription activation and user identification authentication process to provide network access and service. To enable on-demand subscription and user identification management in the evolving digital market, so far, the 3GPP network does not have any digital subscription and identification handling method neither any standard Subscription onboarding method.

Described herein are procedures to support Digital ID based subscriber identification and authentication to enable on-demand network access and to prevent ID frauds. Currently, the traditional mobile subscription ID will be in formats, such as IMSI (with MSIN, MCC, MNC) or NAI. To support a dynamic and temporary subscriptions for the end-user related to On-demand service/pay per use model, a digital subscription unique permanent ID (D-SUPI) may be constructed by the UE based on the digital ID/decentralized ID or the UE's can be provisioned with the digital ID/decentralized ID to support digital user/network/service subscription identification and handling with D-SUPI.

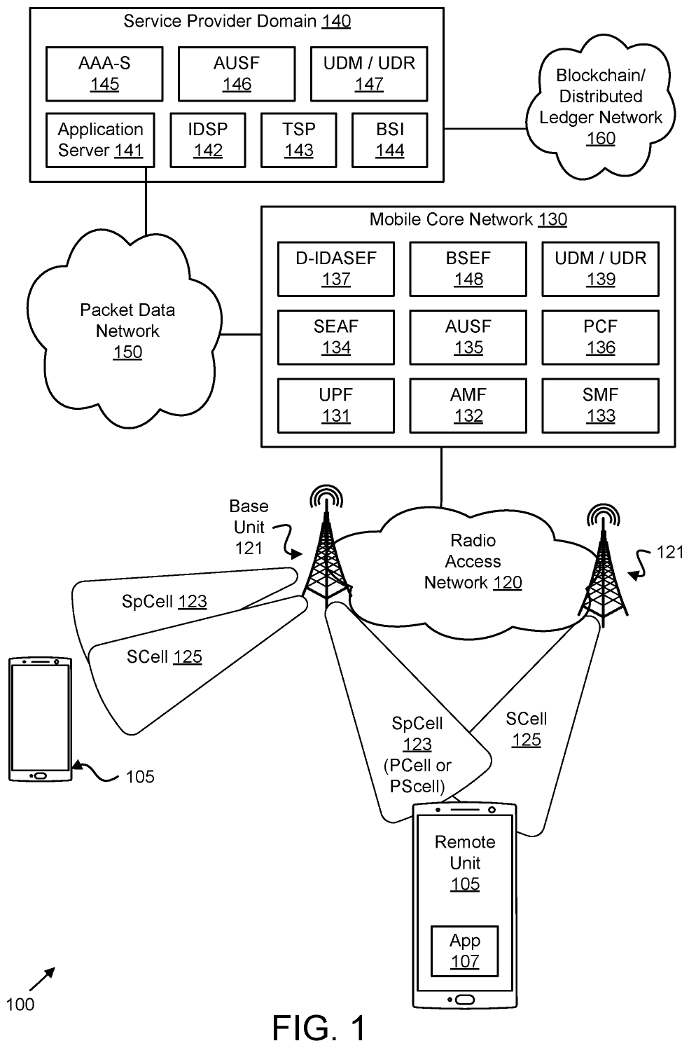

FIG. 1 depicts a wireless communication system 100 for Digital ID-based authentication for network access, according to embodiments of the disclosure. In one embodiment, the wireless communication system 100 includes at least one remote unit 105, a radio access network (“RAN”) 120, a mobile core network 130, and a service provider domain 140. The RAN 120 and the mobile core network 130 form a mobile communication network. The mobile communication network can provide a remote unit 105 with access to one or more services offered by the service provider domain 140. The RAN 120 may be composed of a base unit 110 with which the remote unit 105 communicates using wireless communication links. Even though a specific number of remote units 105, base units 110, RANs 120, mobile core networks 130, and service provider domains 140 are depicted in FIG. 1, one of skill in the art will recognize that any number of remote units 105, base units 110, RANs 120, mobile core networks 130 and service provider domains 140 may be included in the wireless communication system 100.

In one implementation, the RAN 120 is compliant with the 5G system specified in the 3GPP specifications. In another implementation, the RAN 120 is compliant with the LTE system specified in the 3GPP specifications. More generally, however, the wireless communication system 100 may implement some other open or proprietary communication network, for example WiMAX, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the base units 121 in the RAN 120 via uplink (“UL”) and downlink (“DL”) communication signals. Furthermore, the UL and DL communication signals may be carried over the wireless communication links. Here, the RAN 120 is an intermediate network that provides the remote units 105 with access to the mobile core network 130.

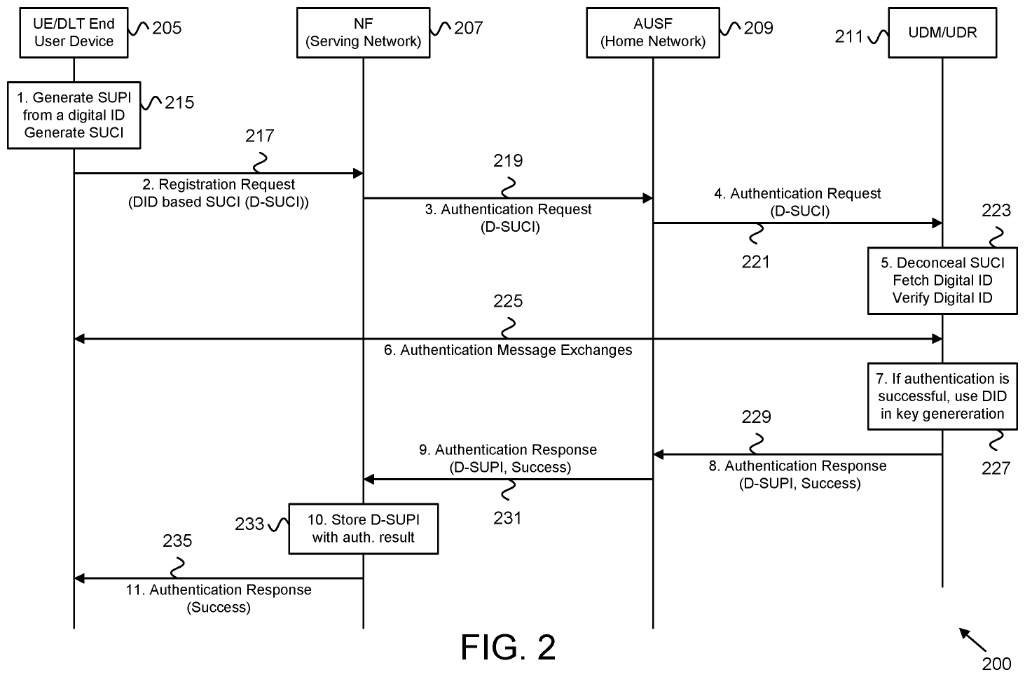

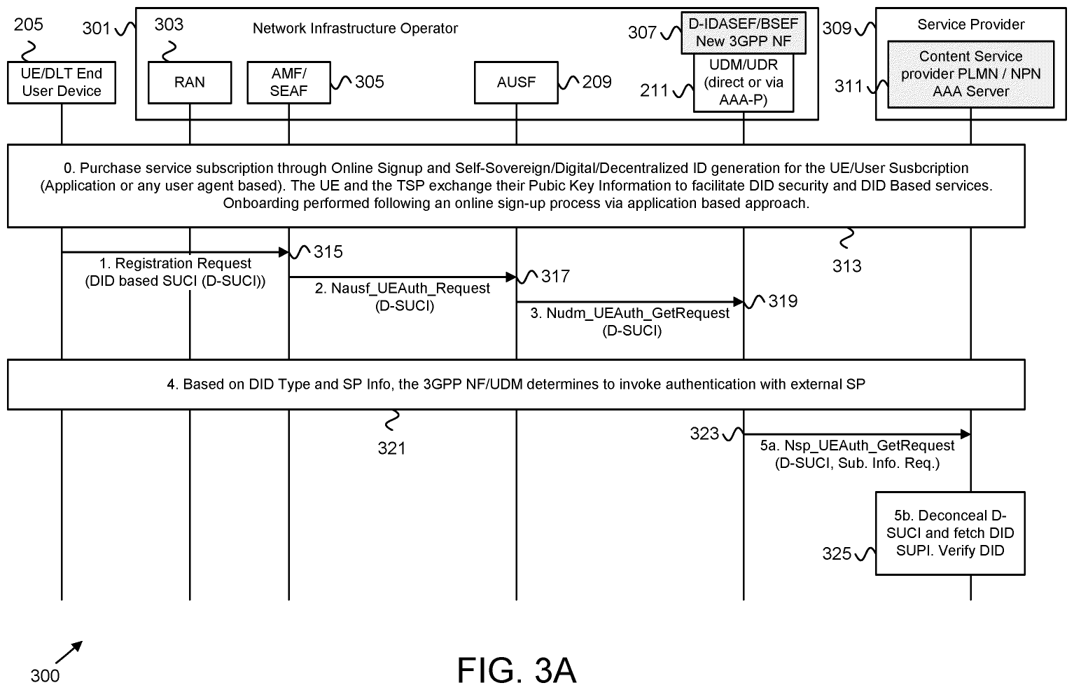

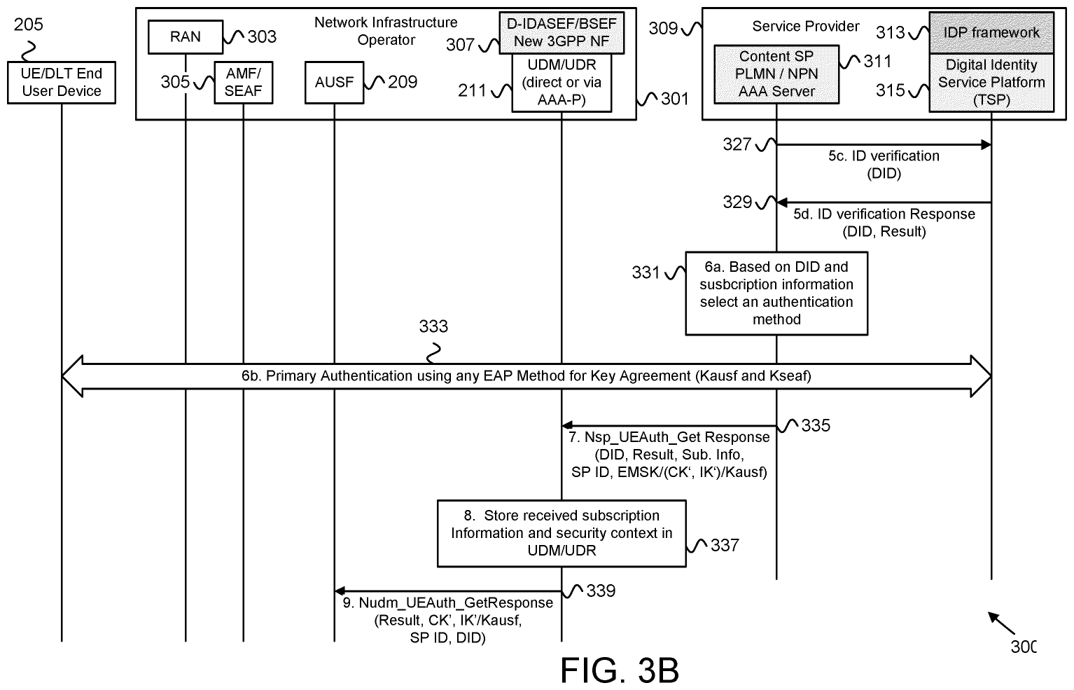

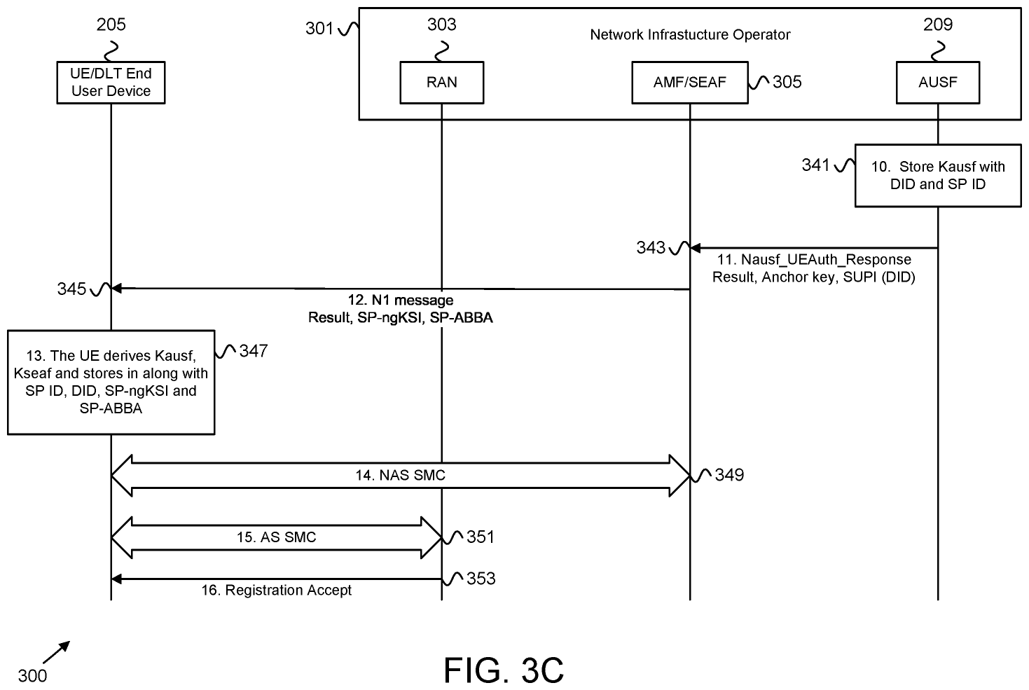

In some embodiments, the remote units 105 communicate with an application server 141 via a network connection with the mobile core network 130. For example, a mobile application 107 (e.g., web browser, media client, telephone/VoIP application) in a remote unit 105 may trigger the remote unit 105 to establish a PDU session (or other data connection) with the mobile core network 130 via the RAN 120. The mobile core network 130 then relays traffic between the remote unit 105 and the application server 141 in the service provider domain 140 using the PDU session. The PDU session represents a logical connection between the remote unit 105 and the UPF 131. In order to establish the PDU session, the remote unit 105 must be registered with the mobile core network 130. Note that the remote unit 105 may establish one or more PDU sessions (or other data connections) with the mobile core network 130. As such, the remote unit 105 may concurrently have at least one PDU session for communicating with the service provider domain 140 and at least one PDU session for communicating with another data network (e.g., the packet data network 150). Other examples of the mobile application 107 include an ID Service application, a Trust Service application, a Subscription Profile Management Service application, a blockchain/DLT client, as discussed below with reference to FIGS. 2-3.

The base units 121 may be distributed over a geographic region. In certain embodiments, a base unit 121 may also be referred to as an access terminal, an access point, a base, a base station, a Node-B, an eNB, a gNB, a Home Node-B, a relay node, a RAN node, or by any other terminology used in the art. The base units 121 are generally part of a radio access network (“RAN”), such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link. As depicted, a base unit 121 may support a special cell 123 (i.e., a PCell or PSCell) and/or a SCell 125. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links. The wireless communication links may be any suitable carrier in licensed or unlicensed radio spectrum. The wireless communication links facilitate communication between one or more of the remote units 105 and/or one or more of the base units 121.

In one embodiment, the mobile core network 130 is a 5G core (“5GC”) or the evolved packet core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes one or more user plane functions (“UPFs”) 131. The mobile core network 130 also includes multiple control plane functions including, but not limited to, an Access and Mobility Management Function (“AMF”) 132 that serves the RAN 120, a Session Management Function (“SMF”) 133, a Security Anchor Function (“SEAF”) 134, an Authentication Server Function (“AUSF”) 135, a Policy Control Function (“PCF”) 136, a Digital Identification, Authentication and trust Services Enabler Function (“D-IDASEF”) 137, and Blockchain Service Enabler Function (“BSEF”) 138, and a Unified Data Management/User Data Repository function (“UDM/UDR”) 139. In various embodiments, the mobile core network 130 may also include a Network Repository Function (“NRF”) (used by the various NFs to discover and communicate with each other over APIs), a Network Exposure Function (“NEF”), or other NFs defined for the 5GC. In various embodiments, the AUSF 135 provides onboarding functions for the mobile core network 130, such as onboard enabler functions. In such embodiments, the AUSF 135 may be an Onboard Enabler AUSF (“O-AUSF”).

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. Each network slice includes a set of CP and/or UP network functions. A network instance may be identified by a S-NSSAI, while a set of network slices for which the remote unit 105 is authorized to use is identified by NSSAI. In certain embodiments, the various network slices may include separate instances of network functions, such as the SMF 133 and UPF 131. In some embodiments, the different network slices may share some common network functions, such as the AMF 132. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 130. Moreover, where the mobile core network 130 is an EPC, the depicted network functions may be replaced with appropriate EPC entities, such as an MME, S-GW, P-GW, HSS, and the like. In certain embodiments, the mobile core network 130 may include a AAA server.

The service provider domain 140 supports services in the wireless communication system 100. Examples of services provided via the service provider domain 140 may include, but are not limited to, 3^{rd} party services (e.g., content service, multimedia service, network service, etc.), Identity services, Trust services, Blockchain services, Distributed Ledger services. As depicted, the service provider domain 140 may include the application server 141, an Identity Service Provider (“IDSP”) 142, a Trust Service Provider (“TSP”) 143, and a Blockchain Service Infrastructure (“BSI”) 144. The IDSP 142 and TSP 143 are described in greater detail, below. The IDSP 142 and TSP 143 provide Identity and Trust services, respectively, to the mobile core network 130 and/or remote unit 105. The BSI 144 interacts with the Blockchain/Distributed Ledger Network 160 to provide blockchain (e.g., distributed ledger) services to the mobile core network 130 and/or remote unit 105. In some embodiments, the service provider domain 140 also includes an Authentication, Authorization and Accounting server (“AAA-S”) 145, where the IDSP 142 and TSP 143 provide Identity and Trust services, respectively, to the AAA-S 145. Alternatively, the BSI 144 interacts with the Blockchain/Distributed Ledger Network 160 to provide blockchain (e.g., distributed ledger) services to the AAA-S 145. In some embodiments, the service provider domain 140 includes an AUSF 146 and a UDM/UDR 147, where the IDSP 142 and TSP 143 provide Identity and Trust services, respectively, to the UDM/UDR 147. Alternatively, the BSI 144 interacts with the Blockchain/Distributed Ledger Network 160 to provide blockchain (e.g., distributed ledger) services to the UDM/UDR 147.

While FIG. 1 depicts components of a 5G RAN and a 5G core network, the described embodiments for Digital ID-based authentication for network access apply to other types of communication networks and RATs, including IEEE 802.11 variants, GSM, GPRS, UMTS, LTE variants, CDMA 2000, Bluetooth, ZigBee, Sigfoxx, and the like. For example, in an LTE variant involving an EPC, the AMF 132 may be mapped to an MME, the SMF 133 may be mapped to a control plane portion of a PGW and/or to an MME, the UPF 131 may be mapped to an SGW and a user plane portion of the PGW, the UDM/UDR 139 may be mapped to an HSS, etc.

In the following descriptions, the term “RAN Node” is used for the base station but it is replaceable by any other radio access node, e.g., gNB, eNB, BS, AP, NR, etc. Further the operations are described mainly in the context of 5G NR. However, the proposed solutions/methods are also equally applicable to other mobile communication systems supporting Digital ID-based authentication for network access.

In various embodiments, the wireless communication system 100 supports registration based on digital SUPI generated from a digital ID available in the UE through online sign-up. The digital SUPI can be constructed by the remote unit 105 based on a user-generated Digital ID acquired during and/or after the online sign up.

As used herein, a Digital ID (“DIG-ID”) refers to a verifiably secure identity and can contain any of the following identities:
Decentralized ID (“DID”): The syntax of DID=“did:” method-name “:” method-specific-id. An example DID is “did:example:123456789abcdefghi”
Self-Sovereign ID (“SSI”): Here, the user or organization (e.g., MNO/Service provider) controls and manages their identity
Digital International Mobile Subscription Identifier (“IMSI”): Here, a digital IMSI may contain a verifiable user ID/digital ID instead of a 10 digit Mobile Subscriber Identification Number (MSIN), example MCC, MNC and verifiable secure user ID/digital ID.
Digital Network Access Identifier (“NAI”) (e.g., having the form <username @realm>, where the username includes a DIG-ID and the realm includes the associated service provider/domain information who have access to the DIG-ID and related information)
Digital International Mobile Equipment Identifier (“IMEI”). Here a digital IMEI may contain a verifiable secure device identifier/digital ID which is linked to the actual IMEI and device information stored in a decentralized platform.

FIG. 2 depicts a procedure 200 for primary authentication using a Digital ID-based SUPI for Network Access and MNO service, according to embodiments of the disclosure. The procedure 200 involves a UE 205, a NF 207 in a serving network (e.g., an AMF), a AUSF 209 in the home network, and a UDM/UDR 211 in the home network. In some embodiments, the serving network is the home network (e.g., H-PLMN). In other embodiments, the serving network is a visited/roaming network (e.g., V-PLMN), different than the home network.

In various embodiments, the UE 205 is one embodiment of the remote unit 105, the NF 207 may be one embodiment of the AMF 132 and/or SEAF 134, the AUSF 209 is one embodiment of AUSF 135, and the UDM/UDR 211 is one embodiment of the UDM/UDR 139. Note that the UE 205 may be a distributed ledger technology (“DLT”) end user device. The procedure 200 shows how a user can use the Digital ID (DIG-ID) as SUPI to request network access, e.g., during network access registration to use a network service. The mobile network operator (“MNO”) may verify the DIG-ID to perform user identity authentication to provide network access.

As a precondition to the procedure 200, the User performs online sign up to buy MNO subscription. During the process of online sign, the user creates a digital ID (for example, a decentralized ID) using an ID service platform and/or trust service platform, which allows the MNO to verify the user DIG-ID via an ID/Trust service provider. The MNO verifies the DIG-ID and post successful DIG-ID verification, the user receives the MNO subscription, and the UE 205 is allowed by the MNO to access service.

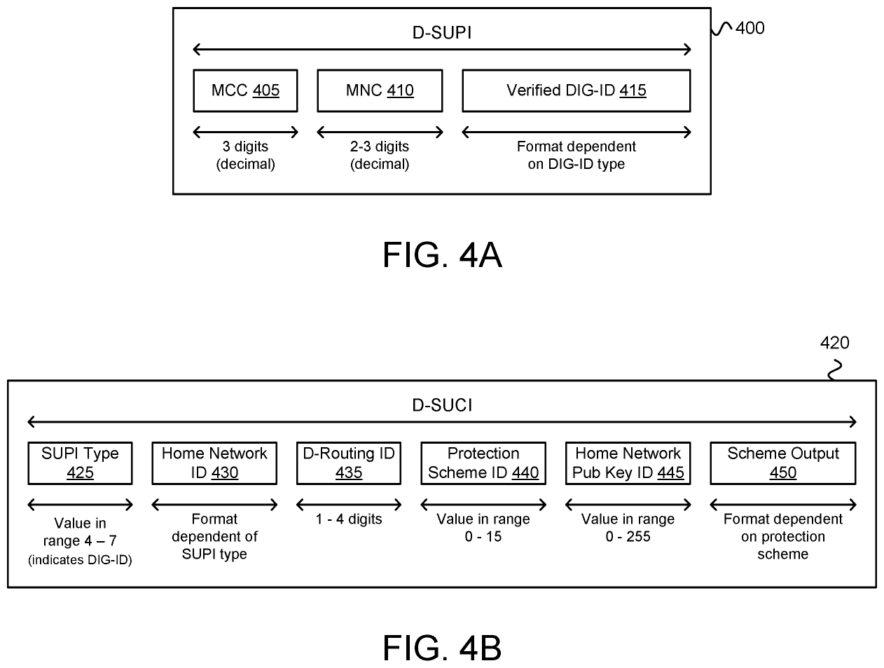

At Step 1, the devices in a trusted platform stores the MNO subscription information along with the verified DIG-ID. The subscription information can also be called as user subscription profile. The subscription information can contain an IMSI (Optional) or Non-IMSI credentials, AKA credentials, network access information, slice information, routing information related to digital subscription (D-Routing Indicator), SUCI generation information and any other network related information. One example of a D-SUCI is described below with reference to FIG. 4B.

The UE 205 determines to use the verified DIG-ID as the network subscription identifier to authenticate with the network for registration to the MNO network. The UE 205 generates the digital SUPI taking the verified DIG-ID as input (see block 215). Further, the UE 205 generates the Digital SUCI (D-SUCI) from the Digital SUPI using the existing SUPI concealment mechanism. One example of a D-SUPI is described below with reference to FIG. 4A.

At Step 2, the User sends the D-SUCI in Registration Request to the NF 207 (e.g., an AMF) in the serving network (see messaging 219).

At Step 3, the NF forwards the received D-SUCI in authentication request to the AUSF 209 in the home network. Alternatively, the NF 207 may forward the authentication request with D-SUCI to another NF in the home network that is configured with functionality to handle DIG-ID-based authentication. In such embodiments, the AUSF 209 in the procedure 200 would be replaced by the other NF, with the below described AUSF 209 behavior being realized by the other NF. Note that the NF 207 sends the authentication request to the home network either directly or via any other NF in the serving network.

At Step 4, the AUSF 209 forwards the received authentication request with D-SUCI based on the digital routing indication information to the UDM instance which handles the digital subscriptions and D-SUCI (see messaging 221).

At Step 5, the UDM 211 de-conceals the D-SUCI into D-SUPI, fetches the DIG-ID, and verifies the obtained DIG-ID, e.g., (see block 223). If the verification is successful, the UDM/UDR 211 selects an authentication method based on DIG-ID. In some embodiments, the UDM 211 verifies the DIG-ID using information locally stored in UDR as part of user subscription information, e.g., a locally-stored DIG-ID. In other embodiments, the UDM 211 verifies the DIG-ID by querying a decentralized blockchain/PDL or an ID service provider/Trust service provider/ID framework.

At Step 6, the UDM/UDR 211 performs authentication method specific message exchange with the UE (see messaging 225).

At Step 7, if the authentication is successful, the UDM/UDR 211 derives a security key (example, A CK; IK or CK′, IK′ or Kausf) using the DIG-ID as one of the inputs in the key derivation (see block 227). However, if an authentication is failed, the UDM/UDR 211 sends an authentication failure message to the UE via the serving network NF.

At Step 8, the UDM/UDR 211 provides the key, D-SUPI, authentication result in authentication response (success) message to the AUSF 209 (see messaging 229).

At Step 9, the AUSF 209 derives another serving network specific security key (e.g., Kseaf) from the key provided by the UDM/UDR 211 using the DIG-ID as one of the inputs in key derivation (see block 231). The AUSF 209 provides the serving network specific security key, D-SUPI, authentication result to the NF 207 (e.g., an AMF) in the serving network either directly or via another NF in the serving network (e.g., SEAF).

At Step 10, the NF 207 (e.g., AMF/SEAF) stores the serving network specific key bound to the DIG-ID and uses it to generate the Non-Access Stratum and Access Stratum level keys for the UE 205 (see block 233).

At Step 11, the NF 207 sends the authentication result to the UE 205 (see messaging 235). The UE 205 further generates the first security key and serving network specific key similar to the network using DIG-ID as the input in the key derivation.

FIG. 3A-3C illustrate a procedure 300 for primary authentication using Digital ID-based SUPI for Network Access, according to embodiments of the disclosure. The procedure 300 may be implemented using the UE 205, a Network Infrastructure Operator 310, and a Service Provider 309. The Network Infrastructure Operator 301 includes the RAN 303, the AMF/SEAF 305, the AUSF 209, and the UDM/UDR 211. Note that the UDM/UDR 211 may access the service provider either directly, or via an AAA-P. In some embodiments, the Network Infrastructure Operator 301 includes a new 3GPP NF which acts an authentication service enabler function such as D-IDASEF and/or BSEF (depicted collectively as the D-IDASEF/BSEF 307). In such embodiments, the AUSF 209 and/or Service Provider 309 may interact with the D-IDASEF/BSEF 307 instead of the UDM/UDR 211, as described in further detail below.

The AMF/SEAF 305 may be embodiments of the AMF 132 and/or SEAF 134. In some embodiments, the AMF/SEAF 305 in an embodiment of the NF 207 in the serving network. The D-IDASEF/BSEF 307 may be embodiments of the D-IDASEF 137 and/or BSEF 138. The service provider 309 includes a NF 311 of a PLMN and/or NPN and/or Content service provider with may act as AUSF/UDM/UDR or an AAA server for the PLMN/NPN/content service provider. In one embodiment, the NF 311 is an embodiment of the AAA-S 145 in the service provider domain 140. In another embodiment, the NF 311 is an embodiment of the AUSF 146 and/or UDM/UDR 147 in the service provider domain 140.

FIGS. 3A-3C depict another scenario used for UE network access registration (e.g., MNO A network) using different 3^{rd} party credentials to use third party service provided by a service provider 309 over the MNO A's network. Here the MNO A and 3^{rd} party can have a service level agreement (“SLA”), for example, where the content service provider offers real-time streaming in a stadium using a different MNO, where the user is not subscriber of that MNO. The procedure 300 is one example of the Pay-per-Use model where the users buy and use services on-the-go without buying a dedicated SIM card.

Regarding User discovery and provisioning: A User discovers the availability of service from content provider B. The User selects network A and performs online sign-up with content provider B. Note that the User may generate a Digital ID (DIG-ID) after successful online sign up with the content provider B. The Content provider B may inform Network A of user specific information and requirements (e.g., along with the DIG-ID).

Regarding Access to Service: The UE 205 accesses Network A with credentials provided by content provider B. Here, the User may access using the DIG-ID as SUPI and associated subscription information provided by the 3^{rd} party. The Network A provides the UE 205 with configuration negotiated with content provider B. The UE 205 sets up the proper PDU session(s), and User enjoys the event and the extra service.

A digital ID based on its usage can be defined as network subscription ID (or) user subscription ID (or) service subscription ID generated/provisioned at the UE by digital means to enable the network to authenticate the user to provide a network access to support different MNO B service or 3rd party service over the MNO's A network. A digital ID is a verifiably secure ID linked to the verifiable claims of the user stored on a trusted and decentralized platform.

The SUPI type field in a SUPI format defined in TS 23.003 can indicate the DIG-ID related SUPI (“D-SUPI”) with any of the following new SUPI types based on the DIG-ID that is used to construct a SUPI/D-SUPI by the UE 205.

A Digital Identifier (“DIG-ID”) may take one of the following forms:

NAI form: username@realm. The username contains information on SUPI type—which is a DIG-ID Type—and the actual ID—which is the DIG-ID. The realm contains information on the domain name/ID which holds the subscription information (or an owner of the subscription) and domain name/ID which provided the DIG-ID (or which offers trust service by providing methods for DIG-ID generation at UE; and facilitates storage of the DIG-ID along with related information in a decentralized platform). An example NAI form of the DIG-ID is as follows: DIG-IDType.DIG-ID@ServiceproviderID.ID/TrustserviceproviderID.

Digital form: an example of the DIG-ID is as follows: DIG-IDType.DIG-ID.D-RoutingID.ServiceproviderID.TrustserviceproviderID. Here, the D-Routing ID (i.e., referring to a DIG-ID Routing Identifier or Information) may contain routing information to select the Identity Authentication and trust services Enabler Function (“D-IDASEF”) or AAA-P or Blockchain Service Enabler Function (“BSEF”) or any 3GPP NF configured to perform the DIG-ID based ID verification, and authentication.

A Decentralized Identifier (“DID”) may take one of the following forms:

NAI form: username @realm. The username contains information on SUPI type—which is a DID Type—and the actual ID—which is the DID. The realm contains information on the domain name/ID which holds the subscription information and domain name/ID which provided the DID (or which offers trust service by providing methods for DIG-ID generation at UE; and facilitates storage of the DIG-ID along with related information in a decentralized platform). An example NAI form of the DID is as follows: DIDType.DID@ServiceproviderID.ID/TrustserviceproviderID.

Digital form: an example of the DID in digital form is as follows: DIDType.DID.D-RoutingID.ServiceproviderID.TrustserviceproviderID. Here, the D-Routing ID (i.e., referring to a DID Routing Identifier or Information) may contain routing information to select the D-IDASEF or AAA-P or BSEF or any 3GPP NF configured to perform the DID based ID verification, and authentication.

A Self Sovereign Identifier (“SSI”) may take one of the following forms:

NAI form: The username contains information on SUPI type which is a SSI/DID Type and the actual ID which is the SSI. An example NAI form of the SSI is as follows: SSIType.SSI@ServiceproviderID.ID/TrustserviceproviderID. The realm contains information on the domain name/ID which holds the subscription information and domain name/ID which provided the SSI (or which enabled the SSI generation at UE).

Digital form: an example of the SSI in digital form is as follows: SSIType.SSI.D-RoutingID.ServiceproviderID.TrustserviceproviderID. The D-Routing ID (DID Routing Identifier or Information) can contain routing information to select the Authentication and trust services Enabler Function (“D-IDASEF”) or AAA-P or Blockchain Service Enabler Function (“BSEF”) or any 3GPP NF to perform the SSI based ID verification, and authentication.

Note that the UE 205 may construct the SUCI from the DIG-ID such as DID/SSI-based SUPI types using a method similar to the SUCI construction method used in the 3GPP 33.501 with the following changes:

The SUPI Type is set to a value between 4 and 7 to indicate the DIG-ID/DID/SSI. The Home Network ID is set to a value that indicates a PLMN ID or Service provider ID (e.g., A domain name with realm part specified in NAI format for SUPI). The ID/Trust service provider ID is set to a value that indicates an ID/Trust service provider who provided the DID/SSI (or which enabled the DID/SSI generation at UE). This field can be ignored if a DID/SSI is generated by the UE and stored in a decentralized platform such as a blockchain which is managed and/or can be accessed by a service provider.

The conventional Routing Indicator is replaced with a D-Routing Indicator that indicates the Trust service provider Information/ID as assigned by the related PLMN/NPN/Content service provider. Alternatively, the D-Routing ID can contain routing information to select the D-IDASEF or AAA-P or BSEF or any 3GPP NF to perform the SSI based ID verification, and authentication. The Protection Scheme ID is specified and used by the PLMN/NPN/Content service provider. The Public Key ID represents a public key provisioned by the PLMN or SNPN/Content service provider. The Scheme Output is the output of a public key protection scheme used for D-SUPI protection. In various embodiments, the protection scheme can be similar to the method specified in 3GPP TS 33.501.

In the depicted embodiment of FIGS. 3A-3C, the solution is explained taking the DID as the DIG-ID and the solution is described in terms of the DID. Note, however, that the same procedure and description are applicable to any DIG-ID such a decentralized ID or Self Sovereign ID or any other digital ID, in which case instead of DID, SSI, etc. can be replaced in the message flow and step description for any DIG-ID adaptability.

As a precondition to the procedure 300, at Step 0 the User purchases 3^{rd} party service subscription through Online Signup and Self-Sovereign/Digital/Decentralized ID generation is done for the UE/User Subscription. This may be done using a mobile application of the UE 205 or using a user agent based. The UE 205 and the Trust Service Provider (“TSP”) platform/infrastructure exchange their Public Key Information to facilitate DID security and DID Based services. Onboarding performed following an online sign-up process via application based approach. See block 313.

At Step 1, the UE 205 sends the Registration Request with DID based SUCI (D-SUCI) to the AMF/SEAF (see messaging 315). The UE 205 can create for this PLMN a service subscription profile/USIM or user network subscription profile on the UICC/non-UICC/trusted secure platform/smart secure platform for later usage during primary authentication.

At Step 2, the AMF/SEAF 305 sends a Nausf_UEAuth_Request message to the AUSF 209 with the received DID-based SUCI (referred to as “D-SUCI”). Alternatively, the AMF/SEAF 305, upon receiving the D-SUCI may directly send an Authentication request message to the appropriate D-IDASEF/BSEF 307 or UDM/UDR 211 (or other 3GPP NF) based on the D-Routing ID/Information provided in the D-SUCI. In this case, step 3 is skipped.

At Step 3, the AUSF 209 sends the Nudm_UEAuth_GetRequest/an Authentication Request message to the D-IDASEF/BSEF 307 or UDM/UDR 211 (or other 3GPP NF) based on the D-Routing ID/Information provided in the D-SUCI (see messaging 319).

At Step 4, based on the SUPI Type which indicates a DID/SSI type, the D-IDASEF/B SEF 307 or UDM/UDR 211 (or other 3GPP NF) determines to invoke an authentication of the DID/SSI with the third-party Service provider with which the MNO has SLA (see block 321).

Alternatively, based on the SUPI Type which indicates a DID/SSI type, the D-IDASEF/B SEF 307 or UDM/UDR 211 (or other 3GPP NF) determines to invoke an authentication of the DID/SSI by using the Service provider provisioned DID and related subscription information which is locally available in the UDM/UDR 211. The D-IDASEF/BSEF 307 or UDM/UDR 211 (or other 3GPP NF) de-conceals the D-SUCI to D-SUPI, fetch DID and verify the DID using the locally stored DID.

If the DID verification is successful, then the D-IDASEF/BSEF 307 or UDM/UDR 211 (or other 3GPP NF) selects an authentication method based on the DID and perform authentication with the UE. If the authentication is successful, the D-IDASEF/BSEF 307 or UDM/UDR 211 (or other 3GPP NF) derives the key CK′, IK′/Kausf which can be bound to the DID by using DID as the additional input in the security key generation. In this alternative, steps 5b, 5c, 5d, 6a, 6b, and 7 are skipped. This covers a case where the network operator is pre-provisioned with the DID and DID related user subscription information by the service provider after an onboarding out of 3GPP scope in step 0.

At Step 5a, the D-IDASEF/BSEF 307 or UDM/UDR 211 (or other 3GPP NF) sends an authentication request message (e.g., Nsp_UEAuth_GetRequest message) to the service provider NF 311 (i.e., any NF/AAA Server of a PLMN/NPN/Content service provider) with the D-SUCI and Subscription Request Indication (see messaging 323). In one example, the NF 311 is a UDM of the content service provider (e.g., UDM/UDR 147) such that the authentication request message is sent to the UDM in the service provider domain. In another example, the NF 311 represents both an AUSF and a UDM of the content service provider (e.g., AUSF 146, UDM/UDR 147), such that the authentication request is sent to the UDM in the service provider domain via the AUSF in the service provider domain.

At Step 5b, the Service provider NF 311 will de-conceal the D-SUCI into D-SUPI and fetch the DID (see messaging 325). Note that the Service provider NF 311 can be an AAA-server, AUSF, UDM or any other 3^{rd} party specific network function.

Continuing on FIG. 3B, at Step 5c, the Service provider NF verifies the DID by querying a decentralized blockchain/PDL or an ID service provider/Trust service provider/ID framework (see messaging 327). Alternatively, the Service provider NF may verify the DID using the public key stored in the local memory and verify the DID based on the DID related documents (i.e., verifiable credentials) to validate the DID related user information.

At Step 5d, the Service provider NF receives the DID verification result (as success/failure) from the decentralized blockchain/PDL or ID service provider/Trust service provider/ID framework, accordingly (see messaging 329).

At Steps 6a-b, the Service provider NF based on the DID verification result, if the result is success, selects an authentication method based on D-SUPI/DID (see block 331) and runs a primary authentication with the UE which includes method specific authentication message exchanges (see messaging 333). If the DID verification is failure, the Service provider NF determines to send an authentication failure with DID verification as cause to the D-IDASEF/B SEF 307 or UDM/UDR 211 (or other 3GPP NF) in the operator's network.

At Step 7, the Service provider NF on a successful DID verification and authentication generates the security context which is bound to the DID and Service provider ID and provide the security context (EMSK/CK′, IK′, Kausf) along with the D-SUPI/DID, result ‘Success’, subscription information (slice information or any user/subscriber and subscription related information), SP-ID in an authentication response message (example: Nsp_UEAuth_GetResponse message) to the D-IDASEF/BSEF 307 or UDM/UDR 211 (or other 3GPP NF) (see messaging 335). The D-SUPI/DID and SP ID are used as the additional input in security context (EMSK/CK,′ IK,′ Kausf) key derivation.

Alternatively, the Service provider NF on receiving a failed DID verification, does not run authentication with UE and sends an authentication response message (e.g., Nsp_UEAuth_GetResponse message) to the D-IDASEF/BSEF 307 or UDM/UDR 211 (or other 3GPP NF) with DID, result ‘failure’, and cause as ‘DID Verification failed’.

At Step 8, the D-IDASEF/BSEF 307 or UDM/UDR 211 (or other 3GPP NF) stores the received D-SUPI/DID, SP ID, subscription information along with the result and stores the security context (EMSK/CK′, IK′, Kausf) (see block 337). If D-IDASEF/BSEF 307 (or other 3GPP NF) receives step 7, then the storage of received information in step 7 is done in the UDM/UDR 211. The D-IDASEF/BSEF 307 or UDM/UDR 211 (or other 3GPP NF) further generates the Kausf if an EMSK is received or sends CK′, IK′ pair/Kausf if it is received from the service provider.

Alternatively, D-IDASEF/BSEF 307 or UDM/UDR 211 (or other 3GPP NF) on receiving a failed DID verification/failed authentication as result, will send the Result as ‘Authentication Failed’ to the UE via AUSF and SEAF/AMF. Alternatively, D-IDASEF/BSEF 307 or UDM/UDR 211 (or other 3GPP NF) locally stores the CK′, IK′/Kausf, DID along with the authentication result.

At Step 9, the D-IDASEF/BSEF 307 or UDM/UDR 211 (or other 3GPP NF) sends the CK′, IK′ pair/Kausf along with the authentication result ‘success’, DID SUPI and SP ID to the AUSF (see messaging 339). Alternatively, the D-IDASEF/BSEF 307 or UDM/UDR 211 (or other 3GPP NF) derives the Kseaf from the received Kausf and sends the Kseaf along with the authentication result ‘success’, DID SUPI and SP ID to the AMF/SEAF. In this case, step 8 and is skipped.

Continuing on FIG. 3C, at Step 10, the AUSF 209 locally stores the received DID SUPI and the SP ID along with Kausf (see block 341). The AUSF 209 derives the Kseaf from Kausf using DID as the additional input in key derivation.

At Step 11, the AUSF 209 sends the Nausf_UEAuth_Response message to the AMF/SEAF which includes the Result, Anchor key and DID SUPI (see messaging 343).

At Step 12, the AMF/SEAF 305 assigns the Service provider specific SP-ngKSI and SP-ABBA value to uniquely identify the security feature and UE security context related to the external/3^{rd} party service provider. The AMF/SEAF 305 sends the Result ‘Authentication Success’, SP-ngKSI, SP-ABBA to the UE 205 in a N1 message (see messaging 345). Alternatively, the AMF/SEAF 305 sends the Result ‘Authentication Success’, ngKSI, ABBA to the UE 205 in a N1 message.

At Step 13, the UE 205 on receiving the Result as ‘Authentication Success’, derives the Kausf and Kseaf similar to the network and stores it along with the received SP-ngKSI and SP-ABBA parameter. Alternatively, UE 205 on receiving the Result as ‘Authentication Success’, derives the Kausf and Kseaf similar to the network and stores it along with the received ngKSI and ABBA parameter.

At Step 14, the AMF 305 initiates NAS SMC to set up NAS security and then AMF 305 triggers to initiate a UE initial context set up with the gNB (see messaging 349).

At Step 15, the gNB in the RAN 303 initiates and performs Access Stratum (“AS”) SMC to set up AS security context (see messaging 351).

At Step 16, after a successful AS security set up, a protected Registration Accept message is sent to the UE 205 (see messaging 353). The MNO can later update the network access information and network specific subscription information based on MNO policy using a UE configuration update procedure after the UE 205 registers to the MNO's network.

FIG. 4A illustrates one example of a Digital ID-based SUPI (“D-SUPI”) 400, according to embodiments of the disclosure. As depicted, the D-SUPI 400 contains: a Mobile County Code (“MCC”) 405, a Mobile Network Code (“MNC”) 410, and a Verified DIG-ID 415 (i.e., any digital ID such as DID, SSI, etc.).

FIG. 4B illustrates one example of a Digital ID-based SUCI (“D-SUCI”) 420, according to embodiments of the disclosure. As depicted, the D-SUCI 420 contains: a SUPI Type 425, a Home Network Identifier 430, D-Routing ID 435, a Protection Scheme ID 440, a Home Network Public Key ID 445, and a Scheme Output 450. Note that the SUPI Type 425 is set to a value corresponding to ‘Digital Identifier’. Currently, the following SUPI-type values are defined: ‘0’ indicates an IMSI; ‘1’ indicates a Network Specific Identifier (“NSI”); ‘2’ indicates a Global Line Identifier (“GLI”); ‘3’ indicates a Global Cable Identifier (“GCI”). Because values in the range 4 to 7 are currently spare values reserved for future use, it is anticipated that a value between 4 and 7 will be used to indicate the SUPI-type corresponds to ‘Digital Identifier’ type or corresponds to any of the following types ‘Decentralized ID’, ‘Self Sovereign ID’, ‘verifiably secure user ID’, ‘verifiably secure device ID’, ‘verifiably secure service ID’, ‘verifiably secure subscription ID’, and/or ‘verifiably secure subscriber ID’.

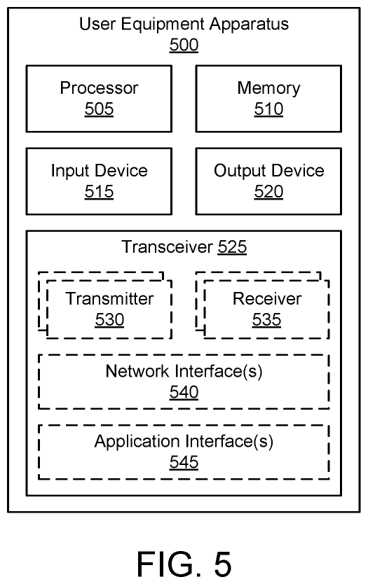

FIG. 5 depicts a user equipment apparatus 500 that may be used for Digital ID-based authentication for network access, according to embodiments of the disclosure. In various embodiments, the user equipment apparatus 500 is used to implement one or more of the solutions described above. The user equipment apparatus 500 may be one embodiment of the remote unit 105 and/or the UE 205, described above. Furthermore, the user equipment apparatus 500 may include a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more serving cells supported by one or more base units 121. Additionally, the transceiver 525 may support at least one network interface 540 and/or application interface 545. The application interface(s) 545 may support one or more APIs. The network interface(s) 540 may support 3GPP reference points, such as Uu and PC5. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the processor 505 controls the user equipment apparatus 500 to implement the above described UE behaviors. For example, the processor 505 acquires a DIG-ID, said DIG-ID comprising a verifiably secure identity. In certain embodiments, acquiring the DIG-ID includes purchasing a subscription associated with the mobile communication network/3^{rd} party service provider and/or generating the DIG-ID at the user equipment apparatus.

The processor 505 generates a UE permanent identifier using the DIG-ID, where the UE permanent identifier indicates a service provider holding subscription information of the UE and a trust service provider that enabled the DIG-ID generation at the UE (user equipment apparatus). Alternatively, the UE permanent identifier can be termed as User Subscription Identifier/Subscription Unique Identifier. In various embodiments, the DIG-ID is generated only at the user equipment apparatus 500, e.g., via a User agent and/or mobile application and/or digital wallet (which can offer trust service and enables Public key infrastructure to generate a verifiable secure ID and digital signatures with cryptographic algorithms). The generated DIG-ID—along with the related documents and/or information and/or verifiable credentials—will also be stored in a decentralized platform (e.g., a digital ID infrastructure) which can be accessed by any verifier (e.g., MNO and/or 3^{rd} party service providers), either directly or through a trust service provider, to verify the DIG-ID.

Via the transceiver 525, the processor 505 sends a Registration request message to a mobile communication network and performs authentication using the DIG-ID, where the user equipment apparatus 500 accesses a service provided by the service provider via the mobile communication network in response to successful authentication.

In some embodiments, the processor 505 constructs a concealed DIG-ID-based identifier (i.e., D-SUCI) from the UE permanent identifier (i.e., DIG-ID or D-SUPI). In such embodiments, the Registration request message includes the concealed DIG-ID-based identifier. Here, the concealed DIG-ID-based identifier includes a type-indicator with a value that indicates a digital identifier type (e.g., DIG-ID/DID/SSI/Verifiable ID type) of the UE permanent identifier.

In certain embodiments, the concealed DIG-ID-based identifier further includes routing information including one or more of: a Service provider ID, a Service provider public Key ID, and a DIG-ID Routing Indicator. In such embodiments, the routing information is usable by the access management function to route the request message to a particular network function which handles DIG-ID-based user ID authentication. In certain embodiments, the request message includes a digital signature and the concealed DIG-ID-based identifier if it does not include a Service provider public Key ID, in response to using a plain text DIG-ID or using a null scheme to construct the concealed DIG-ID-based identifier (i.e., the D-SUCI).

In some embodiments, the DIG-ID includes one or more of: a network subscription identifier, a user subscription identifier, a verifiable user identifier, a DID, a SSI, a verifiable subscription identifier, and a service subscription identifier. In some embodiments, the DIG-ID is generated and/or provisioned at the UE to enable user authentication at the network to provide network access to support a specific service (i.e., a MNO service or 3rd party service) over the mobile communication network. In some embodiments, the DIG-ID indicates the digital identifier type (i.e., Digital ID/DID/SSI/Verifiable ID type) along with the DIG-ID. In some embodiments, the verifiable secure identity is linked to verifiable credentials of the user that are stored on a trusted and decentralized platform or digital identifier infrastructure associated with the trust service provider and/or an identity service provider.

In some embodiments, the DIG-ID is contained within a username portion of a NAI having the form <username @realm>. In such embodiments, the NAI may include the DIG-ID and at least one of: time stamp (or any freshness parameter such as nonce), digital signature, key related information, trust service provider information and/or identity service provider information. In some embodiments, the verifiably secure identity includes one of: a DID and an SSI.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to Digital ID-based authentication for network access. For example, the memory 510 may store UE identifiers, user identifiers, network function identifiers, encryption keys, security algorithms, digital signatures, message authentication codes, network resource identifiers, and the like. In certain embodiments, the memory 510 also stores program code and related data, such as an operating system or other controller algorithms operating on the apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 includes at least transmitter 530 and at least one receiver 535. One or more transmitters 530 may be used to provide UL communication signals to a base unit 121, such as the UL transmissions described herein. Similarly, one or more receivers 535 may be used to receive DL communication signals from the base unit 121, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an ASIC, or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

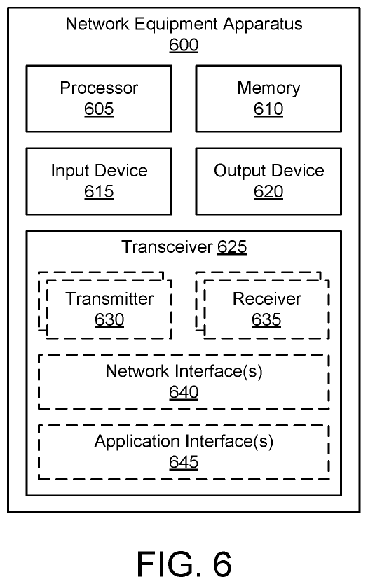

FIG. 6 depicts one embodiment of a network equipment apparatus 600 that may be used for Digital ID-based authentication for network access, according to embodiments of the disclosure. In some embodiments, the network apparatus 600 may be one embodiment of a network function used to implement any of the solutions described above. For example, the network equipment apparatus 600 may comprise hardware and/or software resources to realize one of the above described network functions in a mobile communication network (i.e., PLMN, NPN and/or MNO), such as the AUSF 135, UDM/UDR 139, the UDM/UDR 211, and/or the D-IDASEF/B SEF 307. Furthermore, network equipment apparatus 600 may include a processor 605, a memory 610, an input device 615, an output device 620, and a transceiver 625. In certain embodiments, the network equipment apparatus 600 does not include any input device 615 and/or output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support one or more APIs. The network interface(s) 640 may support 3GPP reference points, such as N1, N3, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the network equipment apparatus 600 to implement the above described network function (“NF”) behaviors. For example, via the network interface 640, the processor 605 receives a first authentication request message, the message containing a UE identifier that is based on a digital identifier (“DIG-ID”), said DIG-ID including a verifiably secure identity.

In various embodiments, the DIG-ID includes one or more of: a network subscription identifier, a user subscription identifier, a verifiable user identifier, a DID, a SSI, a verifiable subscription identifier, and a service subscription identifier. In some embodiments, the DIG-ID is generated and/or provisioned at the UE to enable user authentication at the network to provide network access to support a specific service (i.e., a MNO service or 3rd party service) over the mobile communication network. In some embodiments, the DIG-ID indicates the digital identifier type (i.e., Digital ID/DID/SSI/Verifiable ID type) along with the DIG-ID. In some embodiments, the verifiably secure identity is linked to verifiable credentials of the user that are stored on a trusted and decentralized platform or digital identifier infrastructure associated with a trust service provider and/or an identity service provider (or decentralized platform or digital identifier infrastructure can be accessed by the 3^{rd} party service provider).

In some embodiments, the processor 605 determines to authenticate the UE with a service provider. Here, the determination may be based on a DIG-ID-type of the DIG-ID and also based on service provider information associated with the DIG-ID.

The processor 605 receives subscription information from a service provider (e.g., via the network interface 640), said service provider identified using the DIG-ID. In certain embodiments, the DIG-ID is contained within a username portion of a NAI, where the NAI has the form <username@realm>. In such embodiments, the NAI may include the DIG-ID and at least one of: time stamp, digital signature, key related information, trust service provider information and/or identity service provider information. In certain embodiments, the DIG-ID is a DID and/or an SSI.

The processor 605 stores the subscription information and UE security context in response to successful authentication of the UE using the DIG-ID. Here, the UE security context contains at least one security key derived using the DIG-ID. In one embodiment, the processor 605 locally stores the subscription information and UE security context, e.g., in the memory 610. In other embodiments, the processor 605 stores the subscription information and UE security context in a networked storage device, e.g., in a UDR.

In some embodiments, via the network interface 640, the processor 605 sends a second authentication request message to the service provider and receives the UE security context from the service provider in response to successful authentication of the UE. In such embodiments, the second authentication request message contains the DIG-ID-based identifier in either concealed or plaintext form and containing a subscription information request. In one embodiment, the DIG-ID-based identifier is in plaintext form to support an AAA-server verifying the DIG-ID-based identifier in the Service provider network, where the AAA server does not have the capability to support de-concealing features.

Via the network interface 640, the processor 605 transmits the at least one security key to a network function in the mobile communication network. Here, the at least one security key is used to protect traffic of the UE. In some embodiments, the UE derives at least one matching security key corresponding to the UE security context, said derivation based on one or more of: the DIG-ID, PLMN ID, NID, and a SP ID. In some embodiments, the UE security context is bound to one or more of: the DIG-ID, PLMN ID, NID, and to a SP ID. In certain embodiments, the at least one security key is derived further using the SP ID.

In some embodiments, the first authentication request is received from a network function that is an AMF and/or a SEAF. In such embodiments, transmitting the at least one security key includes sending to the AMF and/or SEAF. In certain embodiments, the one security key received at AMF and/or SEAF is used as AMF Key (Kamf) and/or SEAF Key (Kseaf).

In some embodiments, the first authentication request is received from an AUSF. In such embodiments, transmitting the at least one security key includes sending to the AUSF. In certain embodiments, the one security key received at AUSF is used as one or more of: AUSF Key (Kausf), Extended Master Session Key (EMSK) and/or Cipher and Integrity Key (CK,′ IK′).

In some embodiments, the UE identifier that is based on a DIG-ID includes a concealed DIG-ID-based identifier (i.e., D-SUCI). In some embodiments, the processor 605 performs de-concealing on the UE identifier to acquire a permanent identifier of the UE, said permanent identifier also based on the DIG-ID (i.e., D-SUPI). Additionally, the processor 605 may retrieve the DIG-ID and verify the DIG-ID using a locally stored DIG-ID. Here, authentication of the UE is performed in response to successful verification of the DIG-ID.

In certain embodiments, verifying the DIG-ID includes verifying a digital signature of the DIG-ID with a public key corresponding to the user. In certain embodiments, the processor 605 derives the UE security context in response to successful authentication of the UE. Note that De-concealing may be done using a private/secret key related to the service provider public key ID. Alternatively, the Service provider may verify the digital signature of the D-SUCI by using the public key of the subscriber/user.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data relating to Digital ID-based authentication for network access, for example storing UE identifiers, user identifiers, network function identifiers, encryption keys, security algorithms, digital signatures, message authentication codes, network resource identifiers, and the like. In certain embodiments, the memory 610 also stores program code and related data, such as an operating system (“OS”) or other controller algorithms operating on the network equipment apparatus 600 and one or more software applications.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, may include any known electronically controllable display or display device. The output device 620 may be designed to output visual, audible, and/or haptic signals. In some embodiments, the output device 620 includes an electronic display capable of outputting visual data to a user. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, all or portions of the output device 620 may be located near the input device 615.

As discussed above, the transceiver 625 may communicate with one or more remote units and/or with one or more network functions that provide access to one or more PLMNs. The transceiver 625 operates under the control of the processor 605 to transmit messages, data, and other signals and also to receive messages, data, and other signals. For example, the processor 605 may selectively activate the transceiver (or portions thereof) at particular times in order to send and receive messages.

The transceiver 625 may include one or more transmitters 630 and one or more receivers 635. In certain embodiments, the one or more transmitters 630 and/or the one or more receivers 635 may share transceiver hardware and/or circuitry. For example, the one or more transmitters 630 and/or the one or more receivers 635 may share antenna(s), antenna tuner(s), amplifier(s), filter(s), oscillator(s), mixer(s), modulator/demodulator(s), power supply, and the like. In one embodiment, the transceiver 625 implements multiple logical transceivers using different communication protocols or protocol stacks, while using common physical hardware.

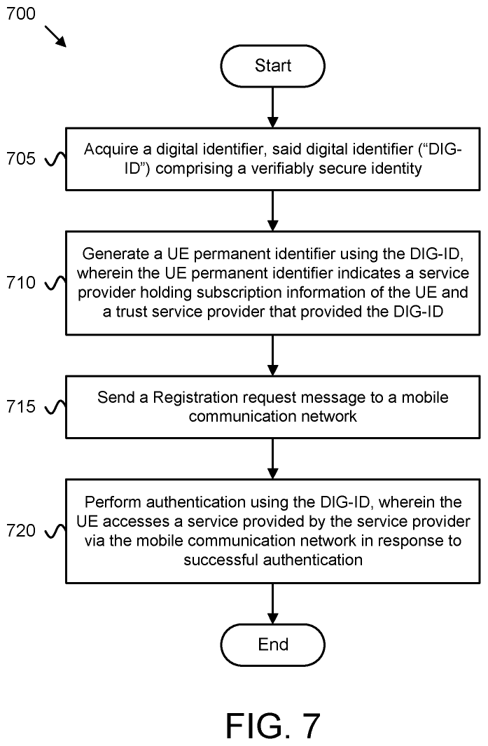

FIG. 7 depicts one embodiment of a method 700 for Digital ID-based authentication for network access, according to embodiments of the disclosure. In various embodiments, the method 700 is performed by a UE, such as the remote unit 105, the UE 205 and/or the user equipment apparatus 500, described above. In some embodiments, the method 700 is performed by a processor, such as a microcontroller, a microprocessor, a CPU, a GPU, an auxiliary processing unit, a FPGA, or the like.

The method 700 begins and acquires 705 a DIG-ID, said DIG-ID comprising a verifiably secure identity. The method 700 includes generating 710 a UE permanent identifier using the DIG-ID. Here, the UE permanent identifier indicates a service provider holding subscription information of the UE and a trust service provider that enabled the DIG-ID generation at the UE (or a Trust service provider which supports in DIG-ID creation and storage of DIG-ID with related information in decentralized platform).

The method 700 includes sending 715 a Registration request message to a mobile communication network. The method 700 includes performing 720 authentication using the DIG-ID. Here, the UE accesses a service provided by the service provider via the mobile communication network in response to successful authentication. The method 700 ends.

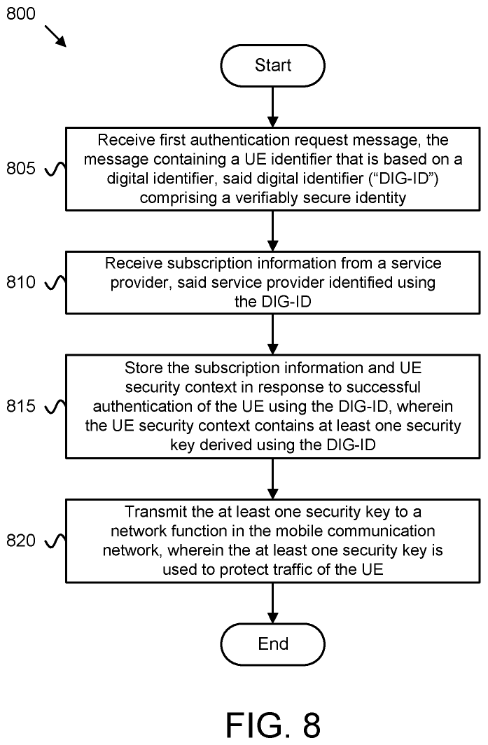

FIG. 8 depicts one embodiment of a method 800 for Digital ID-based authentication for network access, according to embodiments of the disclosure. In various embodiments, the method 800 is performed by a network function, such as the AUSF 135, UDM/UDR 139, the UDM/UDR 211, the D-IDASEF/BSEF 307 and/or the network equipment apparatus 600, described above. In some embodiments, the method 800 is performed by a processor, such as a microcontroller, a microprocessor, a CPU, a GPU, an auxiliary processing unit, a FPGA, or the like.

The method 800 begins and receives 805 a first authentication request message, the message containing a UE identifier that is based on a digital identifier (“DIG-ID”), said DIG-ID comprising a verifiably secure identity. The method 800 includes receiving 810 subscription information from a service provider, said service provider identified using the DIG-ID.

The method 800 includes storing 815 the subscription information and UE security context in response to successful authentication of the UE using the DIG-ID. Here, the UE security context contains at least one security key derived using the DIG-ID. The method 800 includes transmitting 820 the at least one security key to a network function in the mobile communication network. Here, the at least one security key is used to protect traffic of the UE. The method 800 ends.

Disclosed herein is a first apparatus for Digital ID-based authentication for network access, according to embodiments of the disclosure. The first apparatus may be implemented by a UE, such as the remote unit 105, the UE 205 and/or the user equipment apparatus 500, described above. The first apparatus includes a processor that acquires a DIG-ID, said DIG-ID including a verifiably secure identity. The processor generates a UE permanent identifier using the DIG-ID, where the UE permanent identifier indicates a service provider holding subscription information of the UE and a trust service provider that enabled the DIG-ID generation at the UE. The first apparatus includes a transceiver that sends a Registration request message to a mobile communication network. Via the transceiver, the processor performs authentication using the DIG-ID, where the UE accesses a service provided by the service provider via the mobile communication network in response to successful authentication.

In some embodiments, the processor constructs a concealed DIG-ID-based identifier (i.e., D-SUCI) from the UE permanent identifier. In such embodiments, the Registration request message includes the concealed DIG-ID-based identifier. Here, the concealed DIG-ID-based identifier includes a type-indicator with a value that indicates a digital identifier type (e.g., Digital ID/DID/SSI/Verifiable ID type) of the UE permanent identifier.

In certain embodiments, the concealed DIG-ID-based identifier further includes routing information including one or more of: a Service provider ID, a Service provider public Key ID, and a DIG-ID Routing Indicator. In such embodiments, the routing information is usable by the access management function to route the request message to a particular network function which handles DIG-ID-based user ID authentication. In certain embodiments, the request message includes a digital signature and the concealed DIG-ID-based identifier if it does not include a Service provider public Key ID, in response to using a plain text DIG-ID or using a null scheme to construct the concealed DIG-ID-based identifier (i.e., the D-SUCI).

In some embodiments, the DIG-ID includes one or more of: a network subscription identifier, a user subscription identifier, a verifiable user identifier, a DID, a SSI, a verifiable subscription identifier, and a service subscription identifier. In some embodiments, the DIG-ID is generated and/or provisioned at the UE to enable user authentication at the network to provide network access to support a specific service (i.e., a MNO service or 3rd party service) over the mobile communication network. In some embodiments, the DIG-ID indicates the digital identifier type (i.e., Digital ID/DID/SSI/Verifiable ID type) along with the DIG-ID. In some embodiments, the verifiable secure identity is linked to verifiable credentials of the user that are stored on a trusted and decentralized platform or digital identifier infrastructure associated with the trust service provider and/or an identity service provider.

In some embodiments, the DIG-ID is contained within a username portion of a NAI having the form <username @realm>. In such embodiments, the NAI may include the DIG-ID and at least one of: time stamp (or any freshness parameter, such as nonce), digital signature, key related information, trust service provider information and/or identity service provider information. In some embodiments, the verifiably secure identity includes one of: a DID and an SSI.

Disclosed herein is a first method for Digital ID-based authentication for network access, according to embodiments of the disclosure. The first method may be performed by a UE, such as the remote unit 105, the UE 205 and/or the user equipment apparatus 500, described above. The first method includes acquiring a DIG-ID, said DIG-ID including a verifiably secure identity. The first method includes generating a UE permanent identifier using the DIG-ID, where the UE permanent identifier indicates a service provider holding subscription information of the UE and a trust service provider that enabled the DIG-ID generation at the UE. The first method includes sending a Registration request message to a mobile communication network and performing authentication using the DIG-ID, where the UE accesses a service provided by the service provider via the mobile communication network in response to successful authentication.

In some embodiments, the first method includes constructing a concealed DIG-ID-based identifier (i.e., D-SUCI) from the UE permanent identifier. In such embodiments, the Registration request message includes the concealed DIG-ID-based identifier. Here, the concealed DIG-ID-based identifier includes a type-indicator with a value that indicates a digital identifier type (e.g., Digital ID/DID/SSI/Verifiable ID type) of the UE permanent identifier.

In certain embodiments, the concealed DIG-ID-based identifier further includes routing information including one or more of: a Service provider ID, a Service provider public Key ID, and a DIG-ID Routing Indicator. In such embodiments, the routing information is usable by the access management function to route the request message to a particular network function which handles DIG-ID-based user ID authentication. In certain embodiments, the request message includes a digital signature and the concealed DIG-ID-based identifier if it does not include a Service provider public Key ID, in response to using a plain text DIG-ID or using a null scheme to construct the concealed DIG-ID-based identifier (i.e., the D-SUCI).

In some embodiments, the DIG-ID includes one or more of: a network subscription identifier, a user subscription identifier, a verifiable user identifier, a DID, a SSI, a verifiable subscription identifier, and a service subscription identifier. In some embodiments, the DIG-ID is generated and/or provisioned at the UE to enable user authentication at the network to provide network access to support a specific service (i.e., a MNO service or 3rd party service) over the mobile communication network. In some embodiments, the DIG-ID indicates the digital identifier type (i.e., Digital ID/DID/SSI/Verifiable ID type) along with the DIG-ID. In some embodiments, the verifiable secure identity is linked to verifiable credentials of the user that are stored on a trusted and decentralized platform or digital identifier infrastructure associated with the trust service provider and/or an identity service provider.

In some embodiments, the DIG-ID is contained within a username portion of a NAI having the form <username@realm>. In such embodiments, the NAI may include the DIG-ID and at least one of: time stamp (or any freshness parameter, such as nonce), digital signature, key related information, trust service provider information and/or identity service provider information. In some embodiments, the verifiably secure identity includes one of: a DID and an SSI.

Disclosed herein is a second apparatus for Digital ID-based authentication for network access, according to embodiments of the disclosure. The second apparatus may be implemented by a network function in a mobile communication network (i.e., PLMN, NPN and/or MNO), such as the AUSF 135, UDM/UDR 139, the UDM/UDR 211, the D-IDASEF/BSEF 307 and/or the network equipment apparatus 600, described above. The second apparatus includes a network interface that receives a first authentication request message, the message containing a UE identifier that is based on a digital identifier (“DIG-ID”), said DIG-ID including a verifiably secure identity. The network interface receives subscription information from a service provider, said service provider identified using the DIG-ID. The second apparatus includes a processor that stores the subscription information and UE security context in response to successful authentication of the UE using the DIG-ID. Here, the UE security context contains at least one security key derived using the DIG-ID. Via the network interface, the processor transmits the at least one security key to a network function in the mobile communication network. Here, the at least one security key is used to protect traffic of the UE.

In some embodiments, the processor determines to authenticate the UE with the service provider. Here, the determination may be based on a DIG-ID-type of the DIG-ID and also based on service provider information associated with the DIG-ID. In some embodiments, the UE identifier that is based on a DIG-ID includes a concealed DIG-ID-based identifier (i.e., D-SUCI).

In some embodiments, the processor performs de-concealing on the UE identifier to acquire a permanent identifier of the UE, said permanent identifier also based on the DIG-ID. Additionally, the processor may retrieve the DIG-ID and verify the DIG-ID using a locally stored DIG-ID. Here, authentication of the UE is performed in response to successful verification of the DIG-ID. In certain embodiments, verifying the DIG-ID includes verifying a digital signature of the DIG-ID with a public key corresponding to the user. In certain embodiments, the processor derives the UE security context in response to successful authentication of the UE.

In some embodiments, via the network interface, the processor sends a second authentication request message to a service provider and receives the UE security context from the service provider in response to successful authentication of the UE. In such embodiments, the second authentication request message contains the DIG-ID-based identifier in either concealed or plaintext form and containing a subscription information request.

In some embodiments, the UE derives at least one matching security key corresponding to the UE security context, said derivation based on one or more of: the DIG-ID, PLMN ID, NID, and a SP ID. In some embodiments, the UE security context is bound to one or more of: the DIG-ID, PLMN ID, NID, and to a SP ID. In certain embodiments, the at least one security key is derived further using the SP ID.

In some embodiments, the first authentication request is received from a network function that is an AMF and/or a SEAF. In such embodiments, transmitting the at least one security key includes sending to the AMF and/or SEAF. In certain embodiments, the one security key received at AMF and/or SEAF is used as AMF Key (Kamf) and/or SEAF Key (Kseaf).

In some embodiments, the first authentication request is received from an AUSF. In such embodiments, transmitting the at least one security key includes sending to the AUSF. In certain embodiments, the one security key received at AUSF is used as one or more of: AUSF Key (Kausf), Extended Master Session Key (EMSK) and/or Cipher and Integrity Key (CK,′ IK′).

In various embodiments, the DIG-ID includes one or more of: a network subscription identifier, a user subscription identifier, a verifiable user identifier, a DID, a SSI, a verifiable subscription identifier, and a service subscription identifier. In some embodiments, the DIG-ID is generated and/or provisioned at the UE to enable user authentication at the network to provide network access to support a specific service (i.e., a MNO service or 3rd party service) over the mobile communication network. In some embodiments, the DIG-ID indicates the digital identifier type (i.e., Digital ID/DID/SSI/Verifiable ID type) along with the DIG-ID.

In some embodiments, the verifiably secure identity is linked to verifiable credentials of the user that are stored on a trusted and decentralized platform or digital identifier infrastructure associated with a trust service provider and/or an identity service provider. In certain embodiments, the DIG-ID is contained within a username portion of a NAI, where the NAI has the form <username@realm>. In such embodiments, the NAI includes the DIG-ID and at least one of: time stamp (or any freshness parameter, such as nonce), digital signature, key related information, trust service provider information and/or identity service provider information. In certain embodiments, the verifiably secure identity is a DID and/or an SSI.

Disclosed herein is a second method for Digital ID-based authentication for network access, according to embodiments of the disclosure. The second method may be performed by a network function in a mobile communication network (i.e., PLMN, NPN and/or MNO), such as the AUSF 135, UDM/UDR 139, the UDM/UDR 211, the D-IDASEF/BSEF 307 and/or the network equipment apparatus 600, described above. The second method includes receiving a first authentication request message, the message containing a UE identifier that is based on a digital identifier (“DIG-ID”), said digital identifier including verifiably secure identity. The second method includes receiving subscription information from a service provider, said service provider identified using the DIG-ID. The second method includes storing the subscription information and UE security context in response to successful authentication of the UE using the DIG-ID. Here, the UE security context contains at least one security key derived using the DIG-ID. The second method includes transmitting the at least one security key to a network function in the mobile communication network. Here, the at least one security key is used to protect traffic of the UE.

In some embodiments, the second method includes determining to authenticate the UE with the service provider, said determination based on a DIG-ID-type of the DIG-ID and also based on service provider information associated with the DIG-ID. In some embodiments, the UE identifier that is based on a DIG-ID includes a concealed DIG-ID-based identifier (i.e., D-SUCI).

In some embodiments, the second method includes de-concealing the UE identifier to acquire a permanent identifier of the UE, said permanent identifier also based on the DIG-ID, retrieving the DIG-ID and verifying the DIG-ID using a locally stored DIG-ID. Here, authentication of the UE is performed in response to successful verification of the DIG-ID. In certain embodiments, verifying the DIG-ID includes verifying a digital signature of the DIG-ID with a public key corresponding to the user. In certain embodiments, the second method further includes deriving the UE security context in response to successful authentication of the UE.

In some embodiments, the second method includes sending a second authentication request message to a service provider and receiving the UE security context from the service provider in response to successful authentication of the UE. In such embodiments, the second authentication request message contains the DIG-ID-based identifier in either concealed or plaintext form and containing a subscription information request.

In some embodiments, the UE derives at least one matching security key corresponding to the UE security context, said derivation based on one or more of: the DIG-ID, PLMN ID, NID, and a SP ID. In some embodiments, the UE security context is bound to one or more of: the DIG-ID, PLMN ID, NID, and to a SP ID. In certain embodiments, the at least one security key is derived further using the SP ID.

In some embodiments, the first authentication request is received from a network function that is an AMF and/or a SEAF. In such embodiments, transmitting the at least one security key includes sending to the AMF and/or SEAF. In certain embodiments, the one security key received at AMF and/or SEAF is used as AMF Key (Kamf) and/or SEAF Key (Kseaf).

In some embodiments, the first authentication request is received from an AUSF. In such embodiments, transmitting the at least one security key includes sending to the AUSF. In certain embodiments, the one security key received at AUSF is used as one or more of: AUSF Key (Kausf), Extended Master Session Key (EMSK) and/or Cipher and Integrity Key (CK,′ IK′).

In various embodiments, the DIG-ID includes one or more of: a network subscription identifier, a user subscription identifier, a verifiable user identifier, a DID, a SSI, a verifiable subscription identifier, and a service subscription identifier. In some embodiments, the DIG-ID is generated and/or provisioned at the UE to enable user authentication at the network to provide network access to support a specific service (i.e., a MNO service or 3rd party service) over the mobile communication network. In some embodiments, the DIG-ID indicates the digital identifier type (i.e., Digital ID/DID/SSI/Verifiable ID type) along with the DIG-ID.

In some embodiments, the verifiably secure identity is linked to verifiable credentials of the user that are stored on a trusted and decentralized platform or digital identifier infrastructure associated with a trust service provider and/or an identity service provider. In certain embodiments, the DIG-ID is contained within a username portion of a NAI, where the NAI has the form <username@realm>. In such embodiments, the NAI includes the DIG-ID and at least one of: time stamp (or any freshness parameter, such as nonce), digital signature, key related information, trust service provider information and/or identity service provider information. In certain embodiments, the verifiably secure identity is a DID and/or an SSI.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a user equipment device (“UE”) comprising:
acquiring a digital identifier (“DIG-ID”), said digital identifier comprising a verifiably secure identity;
generating a UE permanent identifier using the DIG-ID, wherein the UE permanent identifier indicates a service provider holding subscription information of the UE and a trust service provider that enabled the DIG-ID generation at the UE;
sending a Registration request message to a mobile communication network; and
performing authentication using the DIG-ID, wherein the UE accesses a service provided by the service provider via the mobile communication network in response to successful authentication.

2. The method of claim 1, further comprising constructing a concealed DIG-ID-based identifier from the UE permanent identifier, wherein the Registration request message includes the concealed DIG-ID-based identifier, wherein the concealed DIG-ID-based identifier includes a type-indicator with a value that indicates a digital identifier type of the UE permanent identifier.

3. The method of claim 2, wherein the concealed DIG-ID-based identifier further includes routing information comprising one or more of: a Service provider ID, a Service provider public Key ID, and a DIG-ID Routing Indicator, wherein the routing information is usable by the access management function to route the request message to a particular network function which handles DIG-ID-based user ID authentication.

4. The method of claim 2, wherein the request message includes a digital signature and the concealed DIG-ID-based identifier if it does not include a Service provider public Key ID, in response to using a plain text DIG-ID or using a null scheme to construct the concealed DIG-ID-based identifier.

5. The method of claim 1,
wherein the DIG-ID comprises one or more of: a network subscription identifier, a user subscription identifier, a verifiable user identifier, a decentralized identifier (“DID”), a self-sovereign identifier (“SSI”), a verifiable subscription identifier, and a service subscription identifier,
wherein the DIG-ID is generated and/or provisioned at the UE to enable user authentication at the network to provide network access to support a specific service over the mobile communication network,
wherein the DIG-ID indicates the digital identifier type along with the DIG-ID,
wherein the verifiably secure identity comprises one of: a decentralized identifier and a self-sovereign identifier,
wherein the verifiably secure identity is linked to verifiable credentials of the user that are stored on a trusted and decentralized platform or digital identifier infrastructure associated with the trust service provider and/or an identity service provider.

6. The method of claim 5, wherein the DIG-ID is contained within a username portion of a Network Access identifier (“NAI”), said NAI comprising the DIG-ID and at least one of: time stamp, nonce, a freshness parameter, digital signature, key related information, trust service provider information and/or identity service provider information, wherein the NAI has the form <username@realm>.

7. A method of a network function in a mobile communication network, the method comprising:
receiving a first authentication request message, the message containing a UE identifier that is based on a digital identifier (“DIG-ID”), said digital identifier comprising a verifiably secure identity;
receiving subscription information from a service provider, said service provider identified using the DIG-ID;
storing the subscription information and UE security context in response to successful authentication of the UE using the DIG-ID, wherein the UE security context contains at least one security key derived using the DIG-ID,
transmitting the at least one security key to a network function in the mobile communication network, wherein the at least one security key is used to protect traffic of the UE.

8. The method of claim 7, further comprising determining to authenticate the UE with the service provider, said determination based on a DIG-ID-type of the DIG-ID and also based on service provider information associated with the DIG-ID.

9. The method of claim 7, wherein the UE identifier that is based on a DIG-ID comprises a concealed DIG-ID-based identifier.

10. The method of claim 9, the method further comprising:
de-concealing the UE identifier to acquire a permanent identifier of the UE, said permanent identifier also based on the DIG-ID;
retrieving the DIG-ID; and
verifying the DIG-ID using a locally stored DIG-ID, wherein authentication of the UE is performed in response to successful verification of the DIG-ID.

11. The method of claim 10, wherein verifying the DIG-ID comprises verifying a digital signature of the DIG-ID with a public key corresponding to the user, the method further comprising deriving the UE security context in response to successful authentication of the UE.

12. The method of claim 7, further comprising:
sending a second authentication request message to a service provider, the second authentication request message containing the DIG-ID-based identifier in either concealed or plaintext form and containing a subscription information request; and
receiving the UE security context from the service provider in response to successful authentication of the UE.

13. The method of claim 7, wherein the UE derives at least one matching security key corresponding to the UE security context, said derivation based on one or more of: the DIG-ID, PLMN identifier (“PLMN ID”), Network identifier (“NID”), and a service provider identifier (“SP ID”).

14. The method of claim 7, wherein the UE security context is bound to one or more of: the DIG-ID, PLMN identifier (“PLMN ID”), Network identifier (“NID”), and to a service provider identifier (“SP ID”), wherein the at least one security key is derived further using the SP ID.

15. The method of claim 7, wherein the first authentication request is received from a network function that is one of: an access and mobility management function (“AMF”) and a security anchor function (“SEAF”), wherein transmitting the at least one security key comprises sending to the AMF and/or SEAF.

16. The method of claim 15, wherein the one security key received at AMF and/or SEAF is used as AMF Key (K_{amf}) and/or SEAF Key (K_{seaf}).

17. The method of claim 7, wherein the first authentication request is received from an authentication server function (“AUSF”), wherein transmitting the at least one security key comprises sending to the AUSF.

18. The method of claim 17, wherein the one security key received at AUSF is used as one or more of: AUSF Key (K_{ausf}), Extended Master Session Key (EMSK) and/or Cipher and Integrity Key (CK′, IK′).

19. The method of claim 7,
wherein the DIG-ID comprises one or more of: a network subscription identifier, a user subscription identifier, a verifiable user identifier, a decentralized identifier (“DID”), a self-sovereign identifier (“SSI”), a verifiable subscription identifier, and a service subscription identifier,
wherein the DIG-ID is generated and/or provisioned at the UE to enable user authentication at the network to provide network access to support a specific service over the mobile communication network,
wherein the DIG-ID indicates the digital identifier type along with the DIG-ID,
wherein the verifiably secure identity comprises one of: a decentralized identifier and a self-sovereign identifier,
wherein the verifiably secure identity is linked to verifiable credentials of the user that are stored on a trusted and decentralized platform or digital identifier infrastructure associated with the trust service provider and/or an identity service provider.

20. The method of claim 19, wherein the DIG-ID is contained within a username portion of a Network Access identifier (“NAI”), said NAI comprising the DIG-ID and at least one of: time stamp, nonce, a freshness parameter, digital signature, key related information, trust service provider information and/or identity service provider information, wherein the NAI has the form <username@realm>.
